(19) United States
(12) Patent Application Publication
(10) Pub. No.: US 2022/0417624 A1
(43) Pub. Date: Dec. 29, 2022

(54) DYNAMIC NETWORK TOPOLOGY CONTROL

(71) Applicant: NOKIA SOLUTIONS AND NETWORKS OY, Espoo (FI)

(72) Inventor: Jeroen Van Bemmel, Houston, TX (US)

(21) Appl. No.: 17/362,310

(22) Filed: Jun. 29, 2021

(51) Int. Cl. H04Q 11/00

(52) U.S. Cl. CPC H04Q 11/0067; H04Q 11/0005; H04Q 2011/0064; H04Q 2011/009; H04Q 2011/0086; H04Q 2011/0073

(57) ABSTRACT

Various example embodiments for supporting dynamic control of network topologies are presented. Various example embodiments for supporting dynamic control of network topologies may be configured to support dynamic control of a network topology for a network of routers supporting a set of servers (e.g., a web scale network, a datacenter network, or the like). Various example embodiments for supporting dynamic control of network topologies may be configured to support dynamic control of a network topology based on integration of tunable optical ports into routers and connection of the tunable optical ports to optical buses. Various example embodiments for supporting dynamic control of network topologies may be configured to support dynamic control of a network topology based on dynamic configuration of tunable optical ports of routers to support communication over optical buses according to the network topology.

### TECHNICAL FIELD

Various example embodiments relate generally to communication systems and, more particularly but not exclusively, to supporting dynamic control of network topologies in communication systems.

### BACKGROUND

In various communication networks, various communications technologies may be used to support communications.

### SUMMARY

In at least some example embodiments, an apparatus including at least one processor and at least one memory including computer program code, wherein the at least one memory and the computer program code are configured to, with the at least one processor, cause the apparatus at least to obtain optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses, determine, based on the optical connectivity information for the network, optical communication topology configuration information for an optical communication topology to be configured in the network, and initiate, based on the optical communication topology configuration information, configuration of the network to support the optical communication topology. In at least some example embodiments, the optical connectivity information includes, for each tunable optical port in the set of tunable optical ports, an indication as to whether the tunable optical port is configured to transmit optical signals or is configured to receive optical signals. In at least some example embodiments, the optical connectivity information includes, for each tunable optical port in the set of tunable optical ports, an indication as to a bandwidth supported by the tunable optical port. In at least some example embodiments, the optical communication topology configuration information is determined based on information associated with a set of servers supported by the network. In at least some example embodiments, the information associated with the set of servers supported by the network includes at least one of an indication of an application supported by the set of servers, an indication of an application type of an application supported by the set of servers, or an indication of a traffic pattern associated with an application supported by the set of servers. In at least some example embodiments, the information associated with the set of servers supported by the network includes an indication of a switchover of the set of servers between supporting a first application of a first application type and a second application of a second application type. In at least some example embodiments, the optical communication topology configuration information is determined based on information indication of an application-specific benefit function of an application supported by the set of servers. In at least some example embodiments, the application-specific benefit function of the application supported by the set of servers includes at least one of minimization of end user latency, minimization of latency variation, minimization of connectivity, maximization of bandwidth, maximization of redundant paths, or preservation of power. In at least some example embodiments, the optical communication topology configuration information includes, for each tunable optical port in the set of tunable optical ports which is part of the optical communication topology, respective optical port configuration information for the tunable optical port. In at least some example embodiments, the optical port configuration information for the tunable optical port includes at least one of an optical channel to be supported by the tunable optical port or a bandwidth to be supported by the tunable optical port. In at least some example embodiments, for at least one router in the set of routers which is part of the optical communication topology, the optical communication topology configuration information is sent toward a respective Ethernet management port of the at least one router. In at least some example embodiments, for at least one router in the set of routers which is part of the optical communication topology, the optical communication topology configuration information is sent toward the router using at least one configuration message. In at least some example embodiments, the at least one memory and the computer program code are configured to, with the at least one processor, cause the apparatus at least to detect a failure associated with the optical communication topology, wherein the failure includes at least one of a failure of one of the tunable optical ports which is part of the optical communication topology or a failure of one of the optical buses which is part of the optical communication topology, determine, based on the failure associated with the optical communication topology, updated optical communication topology configuration information for the optical communication topology, and initiate, based on the updated optical communication topology configuration information, configuration of the network to support the optical communication topology. In at least some example embodiments, a non-transitory computer-readable medium includes computer program code configured to cause an apparatus to obtain optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses, determine, based on the optical connectivity information for the network, optical communication topology configuration information for an optical communication topology to be configured in the network, and initiate, based on the optical communication topology configuration information, configuration of the network to support the optical communication topology. In at least some example embodiments, a method includes obtaining optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses, determining, based on the optical connectivity information for the network, optical communication topology configuration information for an optical communication topology to be configured in the network, and initiating, based on the optical communication topology configuration information, configuration of the network to support the optical communication topology. In at least some example embodiments, an apparatus includes means for obtaining optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses, means for determining, based on the optical connectivity information for the network, optical communication topology configuration information for an optical communication topology to be configured in the network, and means for initiating, based on the optical communication topology configuration information, configuration of the network to support the optical communication topology.

In at least some example embodiments, a router includes a tunable optical port configured to be connected to an optical bus, at least one processor, and at least one memory including computer program code, wherein the at least one memory and the computer program code are configured to, with the at least one processor, cause the apparatus at least to receive, by the router from a management system, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application, receive, by the router from the management system, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application, and support, by the router, switching between use of the first set of optical port configuration information by the tunable optical port and use of the second set of optical port configuration information by the tunable optical port. In at least some example embodiments, the first application is a first type of application having a first traffic pattern associated therewith and the second application is a second type of application having a second traffic pattern associated therewith. In at least some example embodiments, the first set of optical port configuration information identifies a first optical channel and the second set of optical port configuration information identifies a second optical channel. In at least some example embodiments, the first set of optical port configuration information includes a first wavelength and a first bandwidth, wherein the second set of optical port configuration information includes a second wavelength and a second bandwidth. In at least some example embodiments, the first set of optical port configuration information includes a first set of optical reception parameters or a first set of optical transmission parameters, wherein the second set of optical port configuration information includes a second set of optical reception parameters or a second set of optical transmission parameters. In at least some example embodiments, the switching between use of the first set of optical port configuration information and use of the second set of optical port configuration information is initiated based on at least one of temporal information or an instruction from the management system. In at least some example embodiments, a non-transitory computer-readable medium includes computer program code configured to cause a router to receive, by the router from a management system, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application, receive, by the router from the management system, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application, and support, by the router, switching between use of the first set of optical port configuration information by the tunable optical port and use of the second set of optical port configuration information by the tunable optical port. In at least some example embodiments, a method for use by a router (or other apparatus) includes receiving, by the router from a management system, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application, receiving, by the router from the management system, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application, and supporting, by the router, switching between use of the first set of optical port configuration information by the tunable optical port and use of the second set of optical port configuration information by the tunable optical port. In at least some example embodiments, a router (or other apparatus) includes means for receiving, by the router from a management system, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application, means for receiving, by the router from the management system, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application, and supporting, by the router, means for switching between use of the first set of optical port configuration information by the tunable optical port and use of the second set of optical port configuration information by the tunable optical port.

### BRIEF DESCRIPTION OF THE DRAWINGS

The teachings herein can be readily understood by considering the following detailed description in conjunction with the accompanying drawings, in which:

FIG. 1 depicts an example embodiment of a communication system for illustrating various example embodiments for supporting dynamic network topologies;

FIG. 2 depicts an example embodiment of a network of routers configured to have a topology that is a Petersen graph topology;

FIG. 3 depicts an example of a cost/benefit analysis for a set of network topologies which may be supported based on dynamic control of network topologies;

FIG. 4 depicts an example embodiment of a method for use by a management system to support dynamic control of network topologies;

FIG. 5 depicts an example embodiment of a method for use by a management system to support dynamic control of network topologies;

FIG. 6 depicts an example embodiment of a method for use by a router to support dynamic control of network topologies;

FIG. 7 depicts an example embodiment of a method for use by a router to support dynamic control of network topologies; and

FIG. 8 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

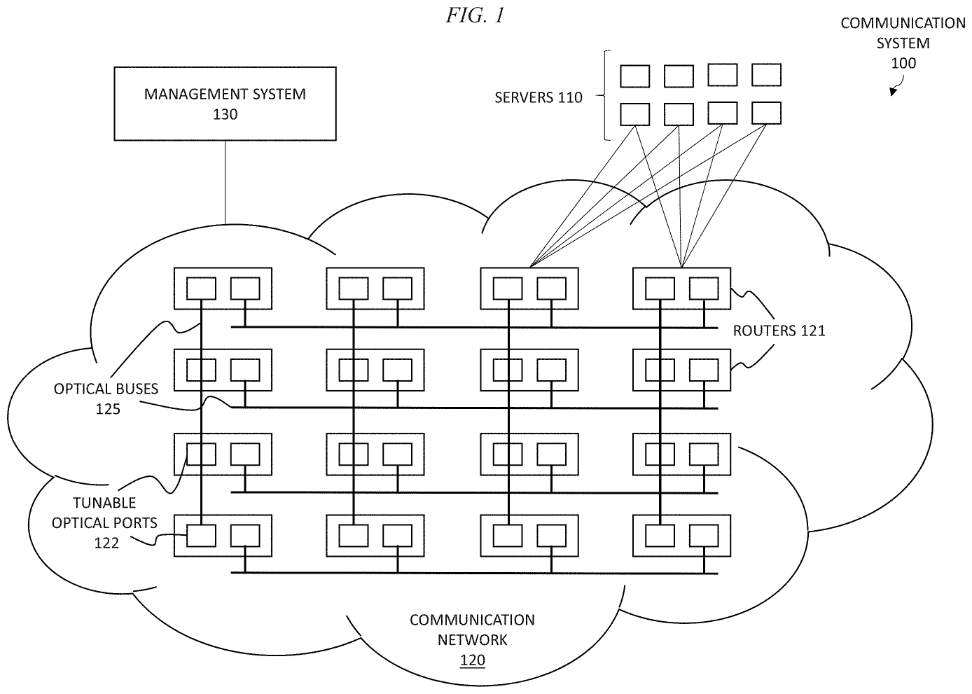

Various example embodiments for supporting dynamic control of network topologies are presented. Various example embodiments for supporting dynamic control of network topologies may be configured to support dynamic control of a network topology of a datacenter network. Various example embodiments for supporting dynamic control of network topologies may be configured to support dynamic control of a network topology of a web scale network. Various example embodiments for supporting dynamic control of network topologies may be configured to support dynamic control of a network topology for a network of routers supporting a set of servers. Various example embodiments for supporting dynamic control of network topologies may be configured to support dynamic control of a network topology based on integration of tunable optical ports into routers and connection of the tunable optical ports to optical buses. Various example embodiments for supporting dynamic control of network topologies may be configured to support dynamic control of a network topology based on dynamic configuration of tunable optical ports of routers to support communication over optical buses according to the network topology. Various example embodiments for supporting dynamic control of network topologies may be configured to support dynamic control of a network topology based on a management system configured to obtain optical connectivity information for a network where the network includes a set of tunable optical ports associated with a set of routers and includes a set of optical buses and where the optical connectivity information includes information indicative of connectivity between ones of the tunable optical ports and ones of the optical buses and information indicative of connectivity between ones of the optical buses, determine, based on the optical connectivity information for the network, optical communication topology configuration information for an optical communication topology to be configured in the network, and initiate, based on the optical communication topology configuration information, configuration of the network to support the optical communication topology. Various example embodiments for supporting dynamic control of network topologies may be configured to support dynamic control of a network topology based on a router configured to receive, by the router from a management system, optical communication topology configuration information associated with an optical communication topology for a network including the router where the optical communication topology configuration information includes optical port configuration information for the tunable optical port and where the optical port configuration information for the tunable optical port includes at least one optical setting for the tunable optical port, and configure, by the router, the tunable optical port to support the at least one optical setting for the tunable optical port. Various example embodiments for supporting dynamic control of network topologies may be configured to support dynamic establishment of various topologies, including various types of complicated topologies which might otherwise be difficult or even impossible to implement (e.g., complicated to compute logically, complicated to connect physically, or the like, as well as various combinations thereof). It will be appreciated that these as well as various other example embodiments, and associated advantages or potential advantages, of supporting dynamic control of network topologies may be further understood by considering the communication system presented in FIG. 1.

FIG. 1 depicts an example embodiment of a communication system for illustrating various example embodiments for supporting dynamic control of network topologies.

The communication system 100 may represent various types of communication systems in which communication networks may be configured to support communications based on configuration of network topologies. For example, communication system 100 may be a web scale communication system, a data center communication system, a network operator communication system, an enterprise communication system, or the like. It will be appreciated that the communication system 100 may represent various other types of communication systems in which communication networks may be configured to support communications based on configuration of network topologies.

The communication system 100 includes a set of servers 110, a communication network 120 configured to support communications of the servers 110, and a management system 130 configured to support management of the communication network 120. The servers 110 are communicatively connected to the communication network 120. The communication network 120 includes a set of routers 121 and a set of optical buses 125. The routers 121 each include a pair of tunable optical ports 122 configured to communicate via the optical buses 125 to which the routers 121 are connected, respectively. The management system 130 is communicatively connected to the communication network 120 for support management of the communication network 120.

The servers 110 may be configured to host various types of application and functions. For example, the servers 110 may be configured to host customer applications (e.g., social media applications, cryptocurrency mining applications, and so forth), virtualized network functions (e.g., load balancers, firewalls, intrusion detection devices, and so forth), or the like, as well as various combinations thereof. The servers 110 may be connected to the communication network 120 via the routers 121 in various ways, such as by using various connection topologies (e.g., single homing such that each server 110 is connected to one of the routers 121, multi-homing such that each server 110 is connected to two or more of the routers 121, and so forth) using various communications technologies (e.g., using Ethernet cabling connections and so forth), or the like, as well as various combinations thereof. The servers 110 may support communications of the various applications and functions via the routers 121 of the communication network.

The routers 121 are configured to support communications of the servers 110. The routers 121 are connected to the servers 110 as well as to the optical buses 125. The routers 121, as indicated above, each include a pair of tunable optical ports 122. The pair of tunable optical ports 122 for a router 121 may include a transmit port configured to support optical transmission over the optical bus 125 to which it is connected (e.g., based on use of electrical-to-optical (E-to-O) transmission, such as based on use of a laser, for optical transmission over the associated optical bus 125) and a receive port configured to support optical reception over the optical bus 125 to which it is connected (e.g., based on use of optical-to-electrical (O-to-E) reception, such as based on use of a diode, for optical reception over the associated optical bus 125). The pair of tunable optical ports 122 for a router 121 may be provided using separate modules for the transmit port and the receive port, using a single module for the transmit port and the receive port (e.g., an optical transceiver including optical transmit and receive ports), or the like. The tunable optical ports 122 may be implemented using various optical capabilities, including various speeds (e.g., 100G, 200G, 400G, or the like), ranges (e.g., short range (SR), long range (LR), long reach multimode (LRM), extended range (XR), ze best range (ZR), ZR+, or the like), technologies (e.g., wavelength division multiplexing (WDM), dense WDM (DWDM), or the like), or the like, as well as various combinations thereof. It will be appreciated that, although each router 121 is primarily presented as including only a pair of tunable optical ports 122, any of the routers 121 may include fewer or more than two tunable optical ports 122. It will be appreciated that various functions which may be supported by the routers 121 and the associated tunable optical ports 122 for supporting dynamic configuration of topologies within the communication network 120 may be further understood by way of reference to a description of dynamic topology configuration as discussed further below.

The tunable optical ports 122 of the routers 121 are tunable to support communications of the servers 110. The tunable optical ports 122 of the routers 121 may be tuned with respect to various parameters, such as optical channel or wavelength for transmission or reception, optical transmitter parameters (e.g., output power, optical return loss, extinction ratio (ER), or the like), optical reception parameters (e.g., receiver signal average power, chromatic dispersion (CD) tolerance, or the like), bit error rate (BER) or associated parameters, quality-of-service (QoS) parameters, or the like, as well as various combinations thereof. The tunable optical ports 122 of the routers 121 are configurable to support various optical channels or wavelengths which may be used to support an optical communication topology within the communication network 120. The tunable optical ports 122 of the routers 121 may be configured, by the routers 121 under the control of the management system 130, such that the routers 121 may communicate over the optical buses 125 according to various optical communication topologies. It will be appreciated that various functions which may be supported by the routers 121 and the associated tunable optical ports 122 for supporting dynamic configuration of optical communication topologies within the communication network 120 may be further understood by way of reference to a description of dynamic topology configuration as discussed further below.

The management system 130 is configured to support management of the communication network 120. The management system 130 may be configured to support configuration of the communication network 120 to support various optical communication topologies. The management system 130 may be configured to support configuration of the communication network 120 to support various optical communication topologies by obtaining optical connectivity information for the communication network 120 (e.g., connectivity information indicative of optical connectivity between the tunable optical ports 122 of the routers 121 and the optical buses 125, optical connectivity between optical buses 125, and so forth), determining, based on the optical connectivity information for the network 120, optical communication topology configuration information for an optical communication topology to be configured in the network 120 (e.g., where the optical communication topology is indicative of optical communication paths to be supported between tunable optical ports 122 of routers 121, via the optical buses 125, to support communications between the routers 121), and configuring, based on the optical communication topology configuration information, the network 120 to support the optical communication topology (e.g., providing the optical communication topology configuration information to the routers 121 for use by the routers 121 for configuring the tunable optical ports 122 of the routers 121 to support the optical communication topology). It will be appreciated that various functions which may be supported by the management system 130 for supporting dynamic configuration of optical communication topologies within communication network 120 may be further understood by way of reference to a description of dynamic topology configuration as discussed further below.

The management system 130 may initiate configuration of the communication network 120 to support the optical communication topology in various ways. The management system 130 may initiate configuration of the communication network 120 to support the optical communication topology periodically (e.g., once per hour, once per day, or the like, as well as various combinations thereof). The management system 130 may initiate configuration of the communication network 120 to support the optical communication topology in response to various conditions, such as conditions associated with the communication network 120 (e.g., a failure of a router 121, a recovery of a previously failed router 121, a failure of a tunable optical port 122, a recovery of a previously failed tunable optical port 122, a failure of an optical bus 125, a recovery of a previously failed optical bus 125, a change in resource utilization within the communication network 120, or the like, as well as various combinations thereof). The management system 130 may initiate configuration of the communication network 120 to support the optical communication topology in various other ways.

The management system 130 may obtain optical connectivity information for the communication network 120, for use in determining the optical communication topology for the communication network 120, which may include various types of optical connectivity information. For example, the optical connectivity information for the communication network 120 may include, for each router 121, an indication of each tunable optical port 122 of the router 121, an indication of communication capabilities of each of the tunable optical ports 122 of the router 121 (e.g., whether the tunable optical port 122 supports optical transmission or optical reception, bandwidth supported by the tunable optical port 122, wavelengths supported by the tunable optical port 122, or the like, as well as various combinations thereof), an indication of physical connectivity of the tunable optical port 122 to an optical bus 125, or the like, as well as various combinations thereof). For example, the optical connectivity information for the communication network 120 may include, for each optical bus 125, an indication of each of the tunable optical ports 122 connected to the optical bus 125, an indication of a bandwidth of the optical bus 125, an indication of any other optical buses 125 to which the optical bus 125 is connected, or the like, as well as various combinations thereof. It will be appreciated that the optical connectivity information for the communication network 120 may include various other types of information.

The management system 130 may obtain the optical connectivity information for the communication network 120, for use in determining the optical communication topology for the communication network 120, in various ways. The management system 130 may obtain the optical connectivity information for the communication network 120 from the communication network 120 (e.g., based on queries to the routers 121 for obtaining optical connectivity information for the communication network 120, based on automated messages originated by the routers 121 for providing the optical connectivity information for the communication network 120, or the like, as well as various combinations thereof). The management system 130 may obtain the optical connectivity information for the communication network 120 from one or more other management systems (e.g., an element management system, a topology information management system, a network provisioning system, or the like, as well as various combinations thereof), which are omitted from FIG. 1 for purposes of clarity. It will be appreciated that the management system 130 may obtain the optical connectivity information for the communication network 120 in various other ways.

The management system 130 may determine the optical communication topology for the communication network 120 based on various types of information. The management system 130, as indicated above, may determine the optical communication topology for the communication network 120 based on the optical connectivity information. The management system 130, in addition to using the optical connectivity information of the communication network 120 to determine the optical communication topology for the communication network 120, may use various other types of information to determine the optical communication topology for the communication network 120.

For example, the management system 130 may determine the optical communication topology for the communication network 120 based on application types or function types of the applications or functions, respectively, hosted on the servers 110. For example, if a first type of application is running on the servers 110 during a first time period (e.g., a social media application or other type of application that is running on the servers 110 during the day) and a second type of application is running on the servers 110 during a second time period (e.g., a cryptocurrency mining application that is running on the servers 110 at night), the management system 130 may reconfigure the communication network 120 from a first optical communication topology that is optimized for supporting traffic of the first application type to a second optical communication topology that is optimized for supporting traffic of the second application type.

For example, the management system 130 may determine the optical communication topology for the communication network 120 based on traffic patterns for applications and functions deployed on the servers 110. For example, if a first traffic pattern is detected for traffic of the servers 110 during a first time period and a second traffic pattern is detected for traffic of the servers 110 during a second time period, the management system 130 may reconfigure the communication network 120 from a first optical communication topology that is optimized for supporting the first traffic pattern to a second optical communication topology that is optimized for supporting the second traffic pattern.

For example, the management system 130 may determine the optical communication topology for the communication network 120 based on analysis of application-specific benefit functions of applications deployed on the servers 110 (e.g., application-related benefit functions, application-declared benefit functions indicated by the applications, or the like). For example, the application-specific benefit function may include at least one of minimization of end user latency, minimization of latency variation, minimization of connectivity, maximization of bandwidth, maximization of redundant paths, preservation of power, or the like, as well as various combinations thereof. For example, if the servers 110 support one or more applications or functions having a benefit function indicative of a goal of minimizing end user latency, the management system 130 may compute the optical communication topology for the communication network 120 such that the optical communication topology is configured to support minimization of end user latency for the applications or functions of the servers 110. For example, if the servers 110 support one or more application or functions having a benefit function indicative of a goal of preserving power, the management system 130 may compute the optical communication topology for the communication network 120 such that the optical communication topology is configured to support conservation of power for the applications or functions of the servers 110. For example, if the servers 110 support one or more application or functions having a benefit function indicative of a goal of minimizing latency variation, the management system 130 may compute the optical communication topology for the communication network 120 such that the optical communication topology is configured to support minimization of latency variation for the applications or functions of the servers 110. It will be appreciated that various other benefit functions may be taken into account by the management system 130 for computing the optical communication topology for the communication network 120. It will be appreciated that various combinations of such benefit functions may be taken into account by the management system 130 for computing the optical communication topology for the communication network 120.

It will be appreciated that at least some such information for determining the optical communication topology for the communication network 120 may be interrelated (e.g., the application types of the applications supported by the servers 110 may have different traffic patterns and so forth) and, thus, that the determination of the optical communication topology for the communication network 120 in such cases may be considered to be based on various combinations of such information for determining the optical communication topology for the communication network 120.

It will be appreciated that various combination of such information for determining the optical communication topology for the communication network 120 may be used. For example, a monitoring application could track traffic patterns for the applications deployed on the servers 110 and, in case a different application gets deployed (e.g., during US daytime a social media application is running, and at night a cryptocurrency mining application takes over) the network connections can be tuned to support application-specific benefit functions (e.g., minimize end user latency, minimize latency variation, minimize connectivity, maximize bandwidth, maximize redundant paths, preserve power, or the like, as well as various combinations thereof). It will be appreciated that various other combination of such information for determining the optical communication topology for the communication network 120 may be used.

The management system 130 may determine the optical communication topology for the communication network 120 based on various other types of information.

The management system 130 may determine the optical communication topology for the communication network 120 in various ways.

The management system 130 may determine the optical communication topology for the communication network 120 by computing one or more optical communication topologies for the communication network 120 and, in the case in which multiple potential optical communication topologies are computed for the communication network 120, selecting one of the multiple potential optical communication topologies for implementation within the communication network 120. For example, the management system 130 may determine the optical communication topology for the communication network by computing a single optical communication topology for the communication network 120 for implementation within the communication network 120 (e.g., computing an optical communication topology that is expected, based on information used to compute the optical communication topology, to be the optimal communication topology for the communication network). For example, the management system 130 may determine the optical communication topology for the communication network 120 by computing multiple potential optical communication topologies for the communication network 120, evaluating each of the multiple potential optical communication topologies for the communication network 120, and selecting, based on the evaluation of multiple potential optical communication topologies for the communication network 120, one of the multiple potential optical communication topologies for the communication network 120 to be used as the optical communication topology for the communication network 120 for implementation within the communication network 120. The evaluation of the potential optical communication topologies for the communication network 120 may include a cost/benefit analysis or other suitable type of evaluation for selecting an optimal optical communication topology for the communication network 120. The evaluation of the potential optical communication topologies for the communication network 120 may be performed by simulating implementation of the optical communication topologies within the communication network 120 and evaluating the optical communication topologies based on the simulated implementations of the optical communication topologies within the communication network 120. The evaluation of the potential optical communication topologies for the communication network 120 may be performed by implementing the optical communication topologies within the communication network 120 and evaluating the optical communication topologies based on the serial implementations of the optical communication topologies within the communication network 120. It will be appreciated that the evaluation of the potential optical communication topologies for the communication network 120 may be performed in various other ways.

The management system 130 may determine the optical communication topology for the communication network 120 by performing channel selections for the tunable optical ports 122 to provide the optical communication topology for the communication network 120. For example, the management system 130 may perform channel selections for the tunable optical ports 122 based on one or more of time selection, frequency selection, wavelength selection, or the like, as well as various combinations thereof. For example, the management system 130 may perform channel selections for the tunable optical ports 122 based on use of network slicing techniques to implement sets of channels which may be configured to support multiple optical communication topology slices on the communication network 120. For example, the management system 130 may perform channel selections for the tunable optical ports 122 based on use of network slicing techniques to implement virtual channels which may be configured to support multiple optical communication topology slices on the communication network 120. It will be appreciated that the management system 130 may utilize various other techniques for determining the optical communication topology for the communication network 120 based on use of channel selections for the tunable optical ports 122 to provide the optical communication topology for the communication network 120.

The management system 130 may determine the optical communication topology for the communication network 120 in various other ways.

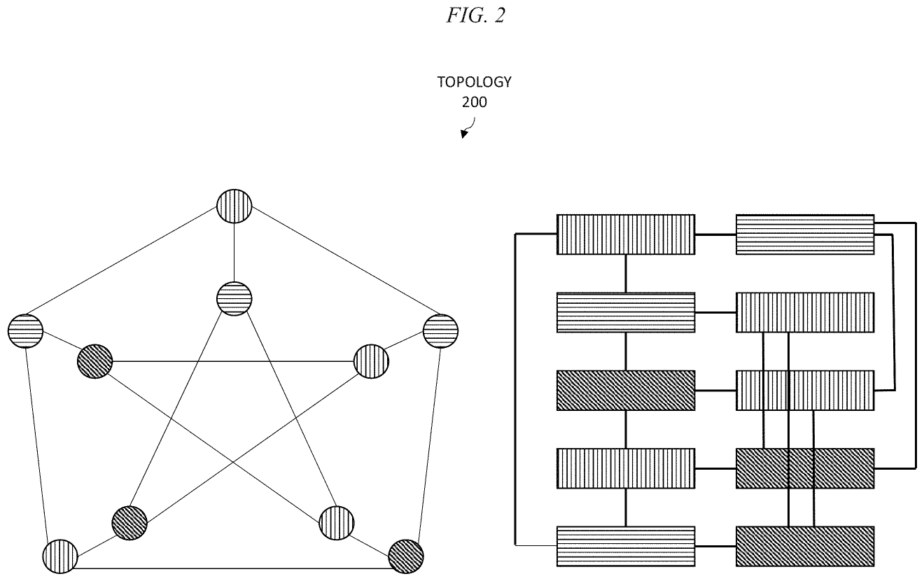

The management system 130 may determine various types of topologies for use as the optical communication topology of the communication network 120. The management system 130 may determine relatively simple topologies, relatively complicated topologies, non-intuitive topologies, arbitrary topologies, or the like. For example, network topologies that may be supported may include a CLOS topology, a “Slim Fly” (SF) topology, a Dragonfly (DF) topology, a Flat Butterfly (FBF) topology, a Hypercube (HC) topology, a Long Hop-HC (LH-HC) topology, a Distributed Loop Network (DLN) topology, a Petersen graph topology, or the like. It is noted that an example embodiment of configuration of a network of routers, based on tunable optical ports and optical buses, to support a Petersen graph topology is presented with respect to FIG. 2. It will be appreciated that various other types of topologies may be determined for use as the optical communication topology of the communication network 120.

The management system 130 may support configuration of the communication network 120 to support the optical communication topology in various ways.

The management system 130 may support configuration of the communication network 120 to support the optical communication topology by determining, based on the optical communication topology for the communication network, optical communication topology configuration information configured for use in configuring the communication network 120 to support the optical communication topology and providing the optical communication topology configuration information to the communication network 120 for triggering configuration of the communication network 120 to support the optical communication topology.

The optical communication topology configuration information may include various types of configuration information use in configuring the communication network 120 to support the optical communication topology. For example, the optical communication topology configuration information may include, for each of the routers 121 which form part of the optical communication topology, configuration information for configuring the router 121 to support the optical communication topology (e.g., optical communication parameters for tunable optical ports 122 of the router 121 which form part of the optical communication topology). For example, the optical communication topology configuration information may include, for each of the tunable optical ports 122 which form part of the optical communication topology, configuration information for configuring the tunable optical port 122 to support the optical communication topology. For example, for tunable optical ports 122 configured to transmit over optical buses 125 for the optical communication topology, the optical communication parameters for the tunable optical ports 122 may include optical channel to be used (e.g., wavelength or the like), optical transmit power, speed to be supported, or the like, as well as various combinations thereof. For example, for tunable optical ports 122 configured to receive over optical buses 125 for the optical communication topology, the optical communication parameters for the tunable optical ports 122 may include optical channel to be used (e.g., wavelength or the like), speed to be supported, or the like, as well as various combinations thereof. It will be appreciated that the optical communication topology configuration information may include various other types of configuration information configured for use in configuring the communication network 120 to support the optical communication topology.

The optical communication topology configuration information may be provided to the communication network 120, for triggering configuration of the communication network 120 to support the optical communication topology, in various ways. For example, the management system 130 may provide the optical communication topology configuration information to the communication network 120 by sending one or more configuration message to each of the routers 121 which form part of the optical communication topology (e.g., sending to each router 121 a single configuration message that includes the configuration information for each of the tunable optical ports 122 of the router 121 being configured to provide the optical communication topology, sending to each router 121 separate configuration messages each of the tunable optical ports 122 of the router 121 being configured to provide the optical communication topology, or the like, as well as various combinations thereof). For example, the management system 130 may provide the optical communication topology configuration information to the communication network 120 by sending configuration messages to management ports of the routers 121 which form part of the optical communication topology (e.g., Ethernet management ports of the routers 121 and/or any other suitable management ports of the routers 121). It will be appreciated that the optical communication topology configuration information may be provided to the communication network 120, for triggering configuration of the communication network 120 to support the optical communication topology, in various other ways.

The management system 130 may initiate configuration of the communication network 120 to support the optical communication topology in various other ways.

It will be appreciated that, although primarily presented with respect to supporting dynamic control of network topologies within a particular type of communication network, various example embodiments for supporting dynamic control of network topologies may be applied within various other types of communication networks.

FIG. 2 depicts an example embodiment of a network of routers configured to have a topology that is a Petersen graph topology. The topology 200 is a topology for a network of routers including ten routers. In FIG. 2, the topology 200 is illustrated in two formats.

In FIG. 2, on the left-hand side of the figure, the topology 200 is illustrated to show the Petersen graph topology, by depicting a rearrangement of the routers to better illustrate the properties of the Petersen graph topology. As depicted on the left-hand side of FIG. 2, the Petersen graph topology includes 10 routers interconnected using 15 edges, in which an outer set of five routers is interconnected to form a pentagon, an inner set of five routers is interconnected to form a star, and the outer set of routers and the inner set of routers are interconnected using direct connections between proximal routers.

In FIG. 2, on the right-hand side of the figure, the topology 200 is illustrated to show the Petersen graph topology, by depicting the physical arrangement of the routers within the data center. As depicted on the right-hand side of FIG. 2, the physical arrangement of the routers within the data center to form the Petersen graph topology that is depicted on the left-hand side of the figure requires relatively complicated and non-intuitive interconnections of the routers within the data center.

It will be appreciated that the Petersen graph topology depicted in FIG. 2 is merely one example of various types of network topologies, including complex, counter-intuitive, and difficult to implement network topologies, which may be supported based on dynamic control of network topologies.

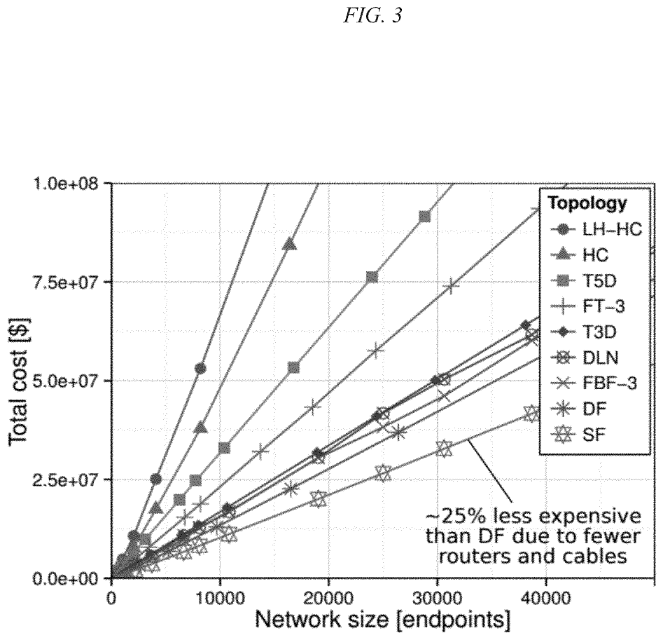

FIG. 3 depicts an example of a cost/benefit analysis for a set of network topologies which may be supported based on dynamic control of network topologies. The cost/benefit analysis illustrates that there are various network topologies which, although complicated, may have significant benefit and relatively low cost. For example, as illustrated in FIG. 3, such topologies may include LH-HC, HC, TSD, FT-3, T3D, DLN, FBF-3, DF, and SF, among others. For example, implementation of an advanced topology like “Slim Fly” (SF) can save up to 25% in capital expenditure (CAPEX) and operational expenditure (OPEX), not accounting for application specific benefits like lower latencies and higher availability, but current data center operators generally are unable to take advantage of these optimizations, because human factor limitations restrict the topologies that can be implemented efficiently and profitably. However, various example embodiments for dynamic control of network topologies presented herein may be used to support dynamic and automated configuration of a datacenter network to support such a “Slim Fly” topology, thereby providing significant benefit to the datacenter operator with relatively low cost. It will be appreciated that the “Slim Fly” topology is merely one example of various types of network topologies, including various complicated network topologies, which may be supported based on use of various example embodiments for dynamic control of network topologies as presented herein.

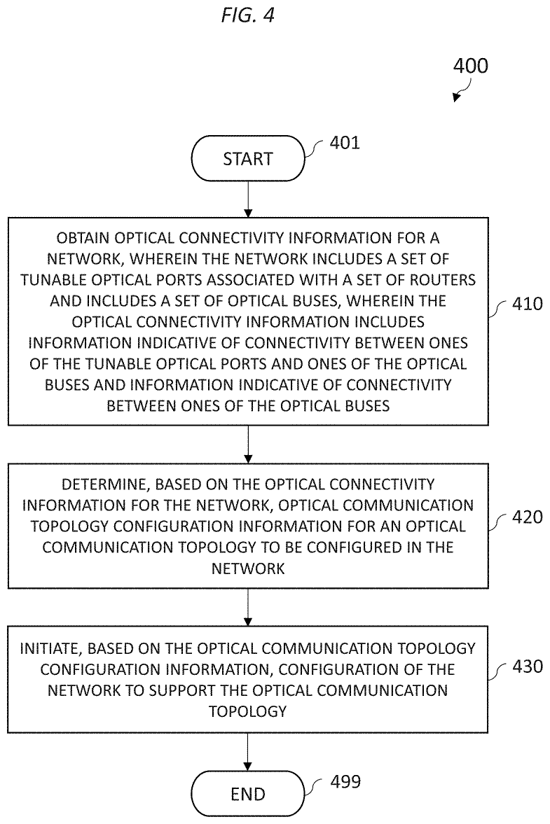

FIG. 4 depicts an example embodiment of a method for use by a management system to support dynamic control of network topologies. It will be appreciated that although primarily presented as being performed serially, at least a portion of the blocks of method 400 may be performed contemporaneously or in a different order than as presented in FIG. 4. At block 401, the method 400 begins. At block 410, obtain optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses. At block 420, determine, based on the optical connectivity information for the network, optical communication topology configuration information for an optical communication topology to be configured in the network. At block 430, initiate, based on the optical communication topology configuration information, configuration of the network to support the optical communication topology. At block 499, the method 400 ends. It will be appreciated that various functions presented within the context of FIG. 1 may be incorporated within the method 400 of FIG. 4.

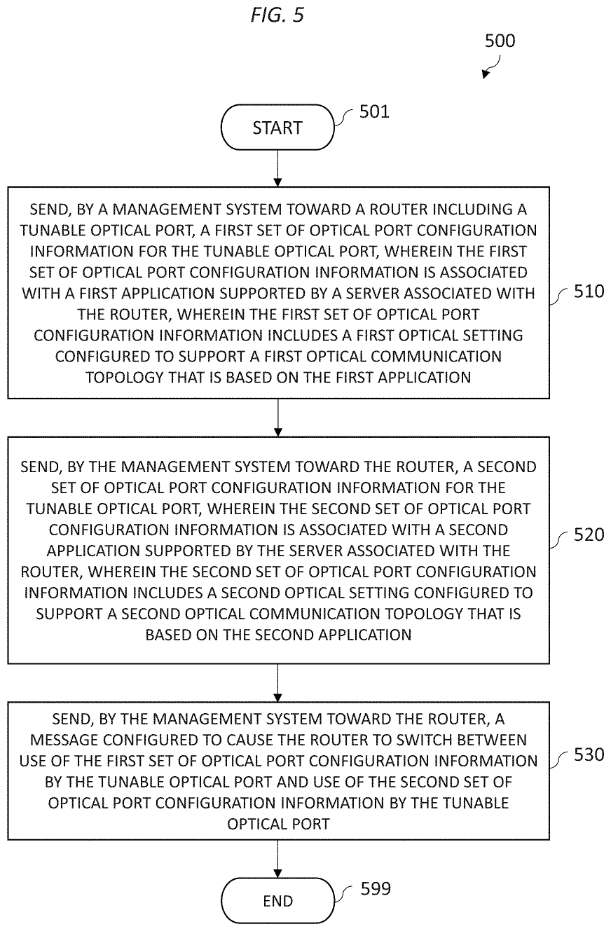

FIG. 5 depicts an example embodiment of a method for use by a management system to support dynamic control of network topologies. It will be appreciated that although primarily presented as being performed serially, at least a portion of the blocks of method 500 may be performed contemporaneously or in a different order than as presented in FIG. 5. At block 501, the method 500 begins. At block 510, send, by a management system toward a router including a tunable optical port, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application. At block 520, send, by the management system toward the router, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application. At block 530, send, by the management system toward the router, a message configured to cause the router to switch between use of the first set of optical port configuration information by the tunable optical port and use of the second set of optical port configuration information by the tunable optical port. At block 599, the method 500 ends. It will be appreciated that various functions presented within the context of FIG. 1 may be incorporated within the method 500 of FIG. 5.

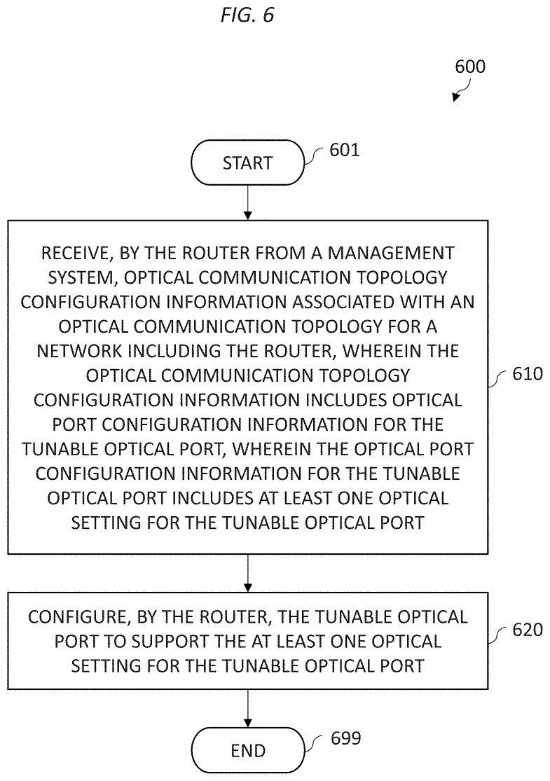

FIG. 6 depicts an example embodiment of a method for use by a router to support dynamic control of network topologies. It will be appreciated that although primarily presented as being performed serially, at least a portion of the blocks of method 600 may be performed contemporaneously or in a different order than as presented in FIG. 6. At block 601, the method 600 begins. At block 610, receive, by the router from a management system, optical communication topology configuration information associated with an optical communication topology for a network including the router, wherein the optical communication topology configuration information includes optical port configuration information for the tunable optical port, wherein the optical port configuration information for the tunable optical port includes at least one optical setting for the tunable optical port. At block 620, configure, by the router, the tunable optical port to support the at least one optical setting for the tunable optical port. At block 699, the method 600 ends. It will be appreciated that various functions presented within the context of FIG. 1 may be incorporated within the method 600 of FIG. 6.

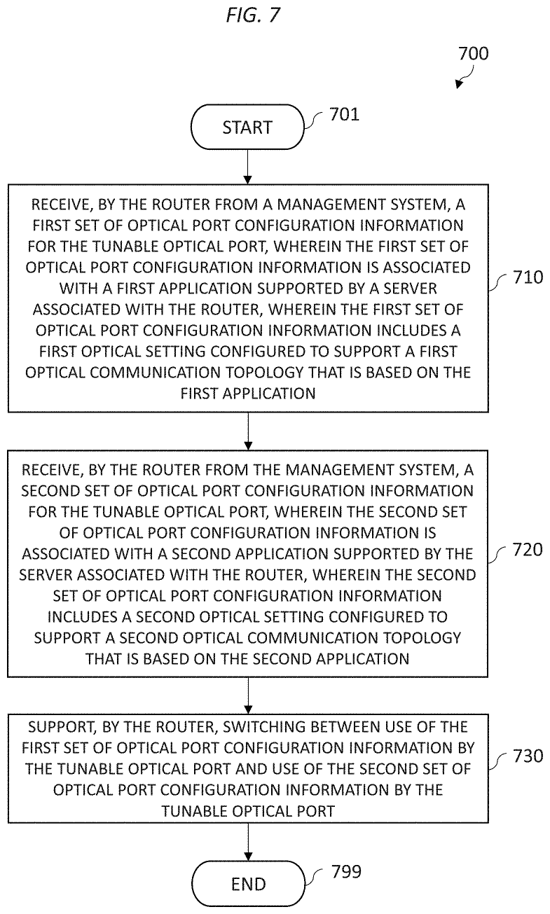

FIG. 7 depicts an example embodiment of a method for use by a router to support dynamic control of network topologies. It will be appreciated that although primarily presented as being performed serially, at least a portion of the blocks of method 700 may be performed contemporaneously or in a different order than as presented in FIG. 7. At block 701, the method 700 begins. At block 710, receive, by the router from a management system, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application. At block 720, receive, by the router from the management system, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application. At block 730, support, by the router, switching between use of the first set of optical port configuration information by the tunable optical port and use of the second set of optical port configuration information by the tunable optical port. At block 799, the method 700 ends. It will be appreciated that various functions presented within the context of FIG. 1 may be incorporated within the method 700 of FIG. 7.

Various example embodiments for supporting dynamic control of network topologies may provide various advantages or potential advantages. For example, various example embodiments for supporting dynamic control of network topologies may be configured to enable dynamic control of topologies in communication networks typically configured with static topologies (e.g., web scale networks, datacenter networks, or the like). For example, various example embodiments for supporting dynamic control of network topologies may be configured to support automated establishment and use of various topologies, including complicated topologies which might otherwise be difficult or even impossible to implement (e.g., complicated to compute logically, complicated to connect physically, or the like, as well as various combinations thereof). For example, various example embodiments for supporting dynamic control of network topologies may be configured to make the interconnect topology in a data center software configurable based on attachment of routers to optical buses using tunable optical ports, thereby enabling management software to program each tunable optical port to communicate on a particular optical channel, thereby enabling the creation of arbitrary communication topologies for the data center. For example, various example embodiments for supporting dynamic control of network topologies may be configured to automatically adapt the interconnect topology of a data center to work around broken components (e.g., if a port or bus fails). For example, various example embodiments for supporting dynamic control of network topologies may be configured to support automated computation and testing of interconnect topologies through software to arrive at a more optimal configuration that may be beyond human cognitive abilities. For example, various example embodiments for supporting dynamic control of network topologies may be configured to provide a feedback loop in which various alternative topologies are tested in sequence and the most optimal one (in terms of cost/benefit function outcome) “wins”, thereby enabling natural selection/evolution of data center topologies and communication network topologies of other communications contexts. For example, various example embodiments for supporting dynamic control of network topologies may be configured to use a slicing feature to implement virtual optical slices (e.g., based on time or frequency band selection) in data centers and other communications contexts. For example, various example embodiments for supporting dynamic control of network topologies may be configured to apply automated algorithmic optimizations for supporting configurable optical communication topologies based on use of tunable optical ports on routers interconnected based on optical buses (e.g., a monitoring application could track traffic patterns for the applications deployed on the servers and, based on the applications or application types deployed and running, may tune the network connections to improve application-specific benefit functions (e.g., minimize end user latency, minimize latency variation, minimize connectivity, maximize bandwidth, maximize redundant paths, preserve power, or the like, as well as various combinations thereof). It will be appreciated that various example embodiments for supporting dynamic control of network topologies may provide various other advantages or potential advantages.

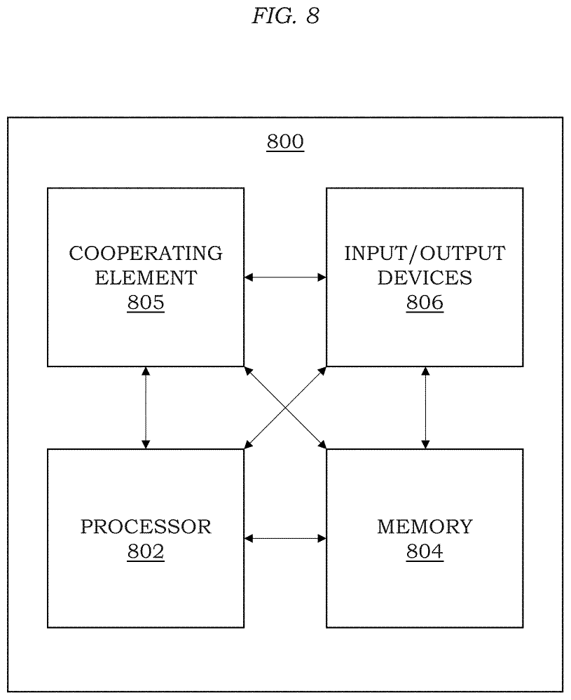

FIG. 8 depicts an example embodiment of a computer suitable for use in performing various functions presented herein.

The computer 800 includes a processor 802 (e.g., a central processing unit (CPU), a processor, a processor having a set of processor cores, a processor core of a processor, or the like) and a memory 804 (e.g., a random access memory, a read only memory, or the like). The processor 802 and the memory 804 may be communicatively connected. In at least some example embodiments, the computer 800 may include at least one processor and at least one memory including a set of instructions, wherein the set of instructions is configured to, when executed by the at least one processor, cause the computer to perform various functions presented herein.

The computer 800 also may include a cooperating element 805. The cooperating element 805 may be a hardware device. The cooperating element 805 may be a process or a set of instructions that can be loaded into the memory 804 and executed by the processor 802 to implement various functions presented herein (in which case, for example, the cooperating element 805 (including associated data structures) can be stored on a non-transitory computer-readable storage medium, such as a storage device or other suitable type of storage element (e.g., a magnetic drive, an optical drive, or the like)).

The computer 800 also may include one or more input/output devices 806. The input/output devices 806 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 800 may represent a general architecture and functionality suitable for implementing functional elements described herein, portions of functional elements described herein, or the like, as well as various combinations thereof. For example, computer 800 may provide a general architecture and functionality that is suitable for implementing one or more elements presented herein, such as a server or a portion thereof, a router or a portion thereof, a tunable optical device (e.g., interface, port, transmitter, receiver, transceiver, or the like) or a portion thereof, a management system or a portion thereof, or the like, as well as various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents). It will be appreciated that at least some of the functions presented herein may be implemented within hardware, for example, as circuitry that cooperates with the processor to perform various functions. It will be appreciated that at least some of the functions presented herein may be implemented by an apparatus including at least one processor and at least one memory including computer program code, wherein the at least one memory and the computer program code are configured to, with the at least one processor, cause the apparatus to perform various functions presented herein. It will be appreciated that portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”). It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
at least one processor; and
at least one memory including computer program code;
wherein the at least one memory and the computer program code are configured to, with the at least one processor, cause the apparatus at least to:
obtain optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses;
determine, based on the optical connectivity information for the network, optical communication topology configuration information for an optical communication topology to be configured in the network; and
initiate, based on the optical communication topology configuration information, configuration of the network to support the optical communication topology.

22. The apparatus of claim 21, wherein the optical connectivity information includes, for each tunable optical port in the set of tunable optical ports, an indication as to whether the tunable optical port is configured to transmit optical signals or is configured to receive optical signals.

23. The apparatus of claim 21, wherein the optical connectivity information includes, for each tunable optical port in the set of tunable optical ports, an indication as to a bandwidth supported by the tunable optical port.

24. The apparatus of claim 21, wherein the optical communication topology configuration information is determined based on information associated with a set of servers supported by the network.

25. The apparatus of claim 24, wherein the information associated with the set of servers supported by the network includes at least one of an indication of an application supported by the set of servers, an indication of an application type of an application supported by the set of servers, or an indication of a traffic pattern associated with an application supported by the set of servers.

26. The apparatus of claim 24, wherein the information associated with the set of servers supported by the network includes an indication of a switchover of the set of servers between supporting a first application of a first application type and a second application of a second application type.

27. The apparatus of claim 21, wherein the optical communication topology configuration information is determined based on information indication of an application-specific benefit function of an application supported by the set of servers.

28. The apparatus of claim 27, wherein the application-specific benefit function of the application supported by the set of servers includes at least one of minimization of end user latency, minimization of latency variation, minimization of connectivity, maximization of bandwidth, maximization of redundant paths, or preservation of power.

29. The apparatus of claim 21, wherein the optical communication topology configuration information includes, for each tunable optical port in the set of tunable optical ports which is part of the optical communication topology, respective optical port configuration information for the tunable optical port.

30. The apparatus of claim 29, wherein the optical port configuration information for the tunable optical port includes at least one of an optical channel to be supported by the tunable optical port or a bandwidth to be supported by the tunable optical port.

31. The apparatus of claim 21, wherein, for at least one router in the set of routers which is part of the optical communication topology, the optical communication topology configuration information is sent toward a respective Ethernet management port of the at least one router.

32. The apparatus of claim 21, wherein, for at least one router in the set of routers which is part of the optical communication topology, the optical communication topology configuration information is sent toward the router using at least one configuration message.

33. The apparatus of claim 21, wherein the at least one memory and the computer program code are configured to, with the at least one processor, cause the apparatus at least to:
detect a failure associated with the optical communication topology, wherein the failure includes at least one of a failure of one of the tunable optical ports which is part of the optical communication topology or a failure of one of the optical buses which is part of the optical communication topology;
determine, based on the failure associated with the optical communication topology, updated optical communication topology configuration information for the optical communication topology; and
initiate, based on the updated optical communication topology configuration information, configuration of the network to support the optical communication topology.

34. A method, comprising:
obtaining optical connectivity information for a network, wherein the network includes a set of tunable optical ports associated with a set of routers and includes a set of optical buses, wherein the optical connectivity information includes information indicative of connectivity between ones of the tunable optical ports and ones of the optical buses and information indicative of connectivity between ones of the optical buses;
determining, based on the optical connectivity information for the network, optical communication topology configuration information for an optical communication topology to be configured in the network; and
initiating, based on the optical communication topology configuration information, configuration of the network to support the optical communication topology.

35. A router, comprising:
a tunable optical port configured to be connected to an optical bus;
at least one processor; and
at least one memory including computer program code;
wherein the at least one memory and the computer program code are configured to, with the at least one processor, cause the apparatus at least to:
receive, by the router from a management system, a first set of optical port configuration information for the tunable optical port, wherein the first set of optical port configuration information is associated with a first application supported by a server associated with the router, wherein the first set of optical port configuration information includes a first optical setting configured to support a first optical communication topology that is based on the first application;
receive, by the router from the management system, a second set of optical port configuration information for the tunable optical port, wherein the second set of optical port configuration information is associated with a second application supported by the server associated with the router, wherein the second set of optical port configuration information includes a second optical setting configured to support a second optical communication topology that is based on the second application; and
support, by the router, switching between use of the first set of optical port configuration information by the tunable optical port and use of the second set of optical port configuration information by the tunable optical port.

36. The router of claim 35, wherein the first application is a first type of application having a first traffic pattern associated therewith and the second application is a second type of application having a second traffic pattern associated therewith.

37. The router of claim 35, wherein the first set of optical port configuration information identifies a first optical channel and the second set of optical port configuration information identifies a second optical channel.

38. The router of claim 37, wherein the first set of optical port configuration information includes a first wavelength and a first bandwidth, wherein the second set of optical port configuration information includes a second wavelength and a second bandwidth.

39. The router of claim 35, wherein the first set of optical port configuration information includes a first set of optical reception parameters or a first set of optical transmission parameters, wherein the second set of optical port configuration information includes a second set of optical reception parameters or a second set of optical transmission parameters.

40. The router of claim 35, wherein the switching between use of the first set of optical port configuration information and use of the second set of optical port configuration information is initiated based on at least one of temporal information or an instruction from the management system.
